(19) United States
(12) Patent Application Publication
(10) Pub. No.: US 2004/0107646 A1
(43) Pub. Date: Jun. 10, 2004

(54) Fixing element for fixing a guide rail for sliding doors

(76) Inventor: Hubert Elmer, Innsbruck (AT)

Correspondence Address: COHEN, PONTANI, LIEBERMAN & PAVANE, 551 FIFTH AVENUE, SUITE 1210, NEW YORK, NY, 10176, US

(21) Appl. No.: 10/473,547

(22) PCT Filed: Apr. 23, 2002
(86) PCT No.: PCT/EP02/04453

(30) Foreign Application Priority Data
Apr. 23, 2001 (DE) 101 19 8855.3

(51) Int. Cl. E05D 13/00

(52) U.S. Cl. 49/410

(57) ABSTRACT

The invention relates to a fixing element (7, 21) for fixing a guide rail (6) for sliding doors (1), in particular glass sliding doors, with a retaining piece (8) and a base piece (10, 23). The retaining piece (8) and he base piece (10, 23) are connected to each other in such a way as to be adjustable in the axial direction X-X relative to each other. The retaining piece (8) comprises a housing section (9), for fixing a guide rail (6). The base piece (10, 23) may be fixed to the furniture body (2), by means of, for example, a screw.

### DESCRIPTION

The present invention is directed to a holding element for holding guide rails for sliding doors, particularly glass sliding doors in furniture.

Guide devices for sliding doors are known in a wide variety of designs. Generally, such guide devices comprise a guide rail and a guide part which can be fastened on the sliding door side, e.g., a track roller or running roller. As is shown, for example, in EP 1 057 963 A2, the guide rail shown therein has a C-shaped fastening groove in which a fastening dowel with a head can be arranged so as to fasten the guide rail in a furniture body. This type of fastening of the guide rail makes for a relatively difficult assembly and leads to a complicated arrangement of the guide rail.

Therefore, it is the object of the present invention to provide a holding element for holding guide rails of sliding doors which securely holds the guide rail, particularly also with heavy sliding doors, in a simple construction that can be manufactured simply and inexpensively.

This object is met by a holding device having the features of claim 1. Advantageous further developments are the subject of the subclaims.

According to the invention, therefore, a holding element is suggested for holding a guide rail for sliding doors in furniture, particularly sliding glass doors, which comprises a holding part and a base part. The holding part and the base part are connected to one another in such a way that they are adjustable relative to one another in axial direction of the holding element. The holding part has a receiving area for holding the guide rail. Further, the base part can be fastened to a furniture body. Accordingly, the invention provides a holding element which is constructed in a simple manner and can hold a guide rail securely. An adjustment of the distance between the guide rail and furniture body is also made possible by the holding element according to the invention by means of an adjusting device arranged between the holding part and the base part. An adjustment can also be carried out when the holding element or guide rail is mounted. This step makes it possible to compensate for tolerances.

To enable a particularly simple adjustment between the holding part and base part of the holding element, the two parts are connected to one another by means of a thread.

A lock nut is preferably provided for reliably fixing a determined adjusting position between the holding part and the base part. This can be constructed in a particularly preferable manner in such a way that it covers the adjusting thread, so that the adjusting capability of the holding element is not outwardly apparent.

In a second construction of a holding element, it is suggested that the visible lock nut be dispensed with. In this case, a coupling nut or union nut is fastened to the holding part in a rotatable manner and has an internal or female thread which is screwed onto an external or male thread of the base part. A lock screw which is adjustable against the bottom of the holding part is located in the base part for locking the holding part and therefore also for fixing the union nut. In this case, the adjustability of the holding element is also not apparent from the outside. The rod contained in the holding part can be brought into the correct position by means of the lock screw for orientation and, accordingly, for correcting (in longitudinal extension) tolerances.

The receiving area of the holding part is preferably circular. A cylindrical guide rail can accordingly be held by the holding element.

According to another preferred construction of the present invention, the receiving area of the holding part is constructed as a partial circle. The partial circle is larger than a half-circle. This prevents a cylindrical guide rail from being removed from the receiving area unintentionally because the receiving area of the holding part engages around the guide rail by more than half of its circumference. The guide rail (rod) can accordingly only be removed in its axial directions.

The partial circle is preferably open in axial direction of the holding element. In this way, it can be ensured when using running rollers that the holding element does not interfere with the displacement of the sliding door or the running of the running roller on the guide rail when the holding element is fastened to an upper or lower surface of a furniture body.

According to another preferred construction of the present invention, the partial circle of the receiving area is open vertical to the axial direction of the holding element. The holding element can accordingly be arranged at a front area of a furniture body without the holding element interfering with a movement of a running roller on the guide rail.

In order to make possible a simple and reliable fastening of the guide rail in the receiving area of the holding element, the guide rail is preferably fixed by means of a stud screw. This can be made visible from the side or invisible in axial direction.

The guide rail is preferably constructed as a cylindrical rod.

In order to make possible a simple fastening of the base part of the holding element to a furniture body, the base part preferably has a through-opening in which a fastening element, e.g., a screw, is received. In this way, the base part can be fastened to the furniture body in a simple manner.

Since the holding element according to the invention is particularly stable due to its construction, it is particularly suitable for use with heavy sliding glass doors. In previously known holding elements, use of heavy glass sliding doors is possible only conditionally since the full weight of a sliding glass door generally leads to problems, particularly also due to the loading caused by the displacement. The holding element is likewise suitable for vertical mounting of a rod in order to connect several pieces of furniture together, for example.

The invention will be described more fully in the following with reference to a number of embodiment examples in connection with the drawings.

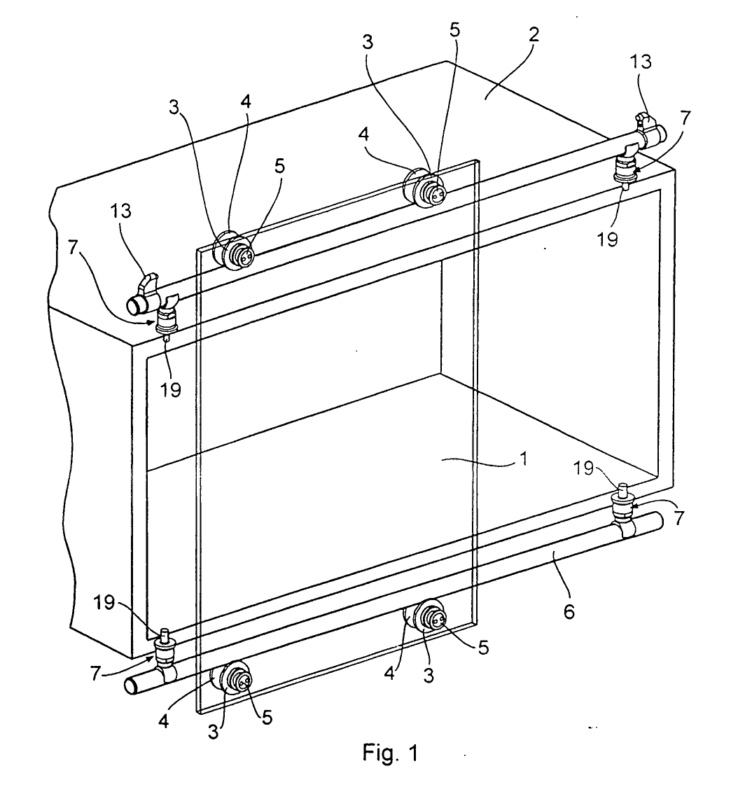

FIG. 1 shows a perspective view of a guide device for a sliding glass door with the holding element according to a first embodiment example of the present invention;

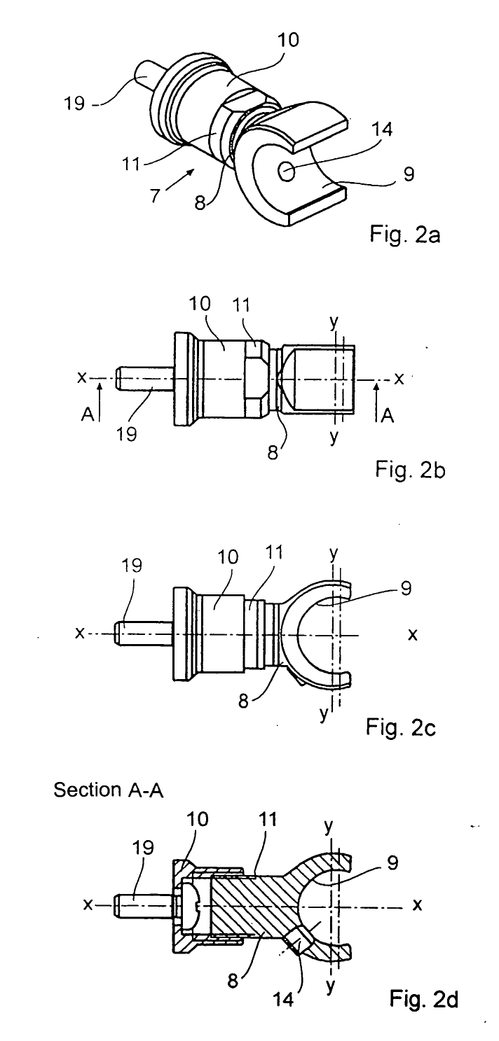

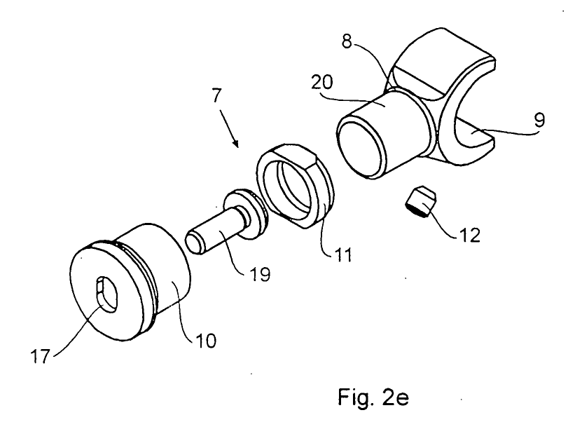

FIGS. 2a to 2e show various views of the holding element according to the first embodiment example of the invention;

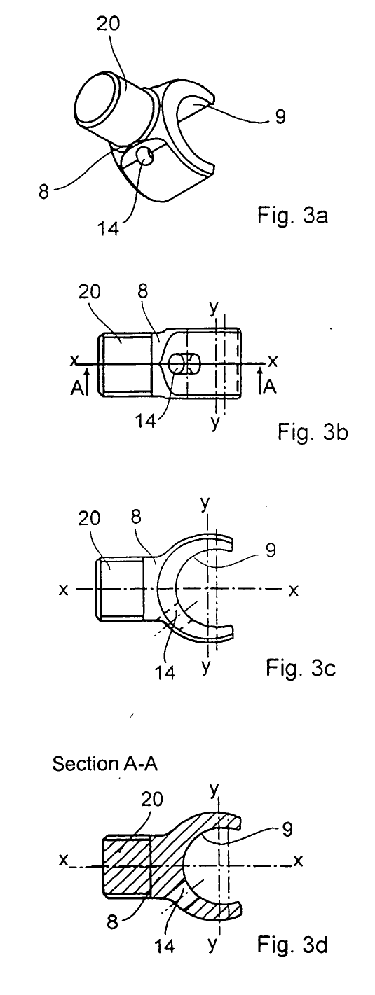

FIGS. 3a to 3d show various views of the holding part of the holding element according to the first embodiment example of the present invention;

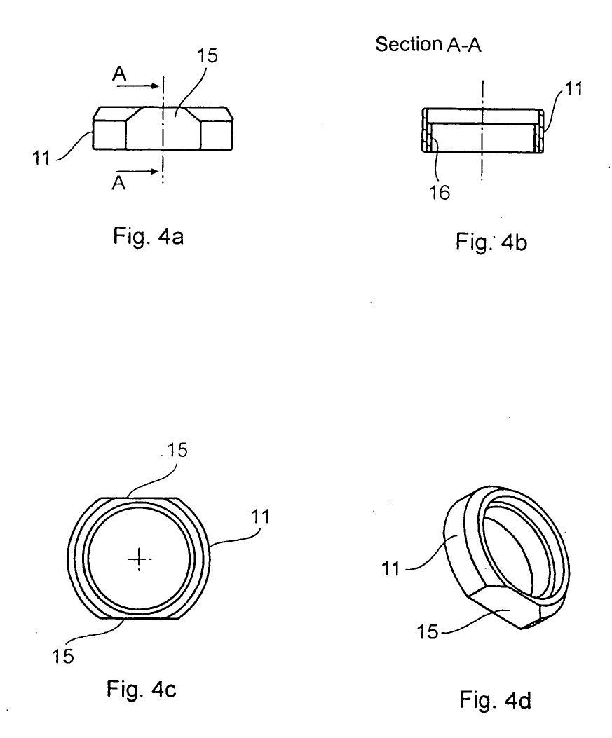

FIGS. 4a to 4d show various views of a lock nut according to the invention for the holding element according to the invention;

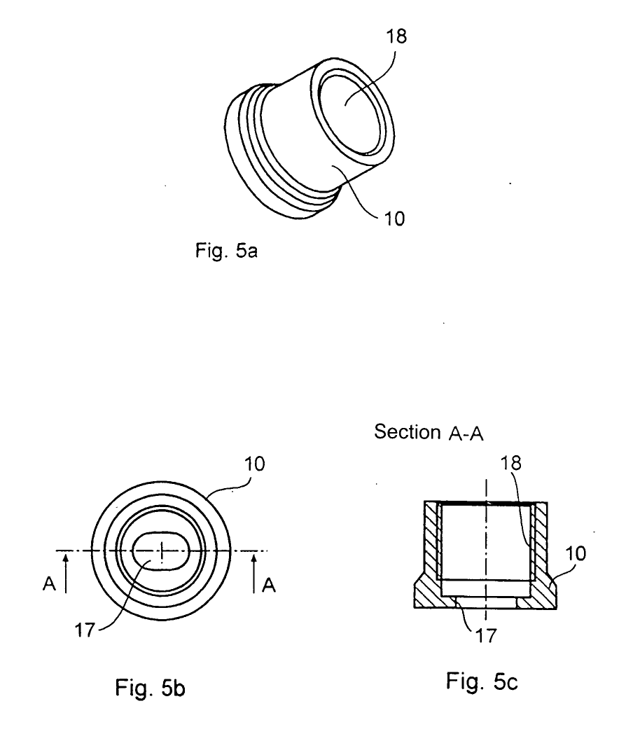

FIGS. 5a to 5c show various views of a base part of the holding element according to the first embodiment example of the present invention;

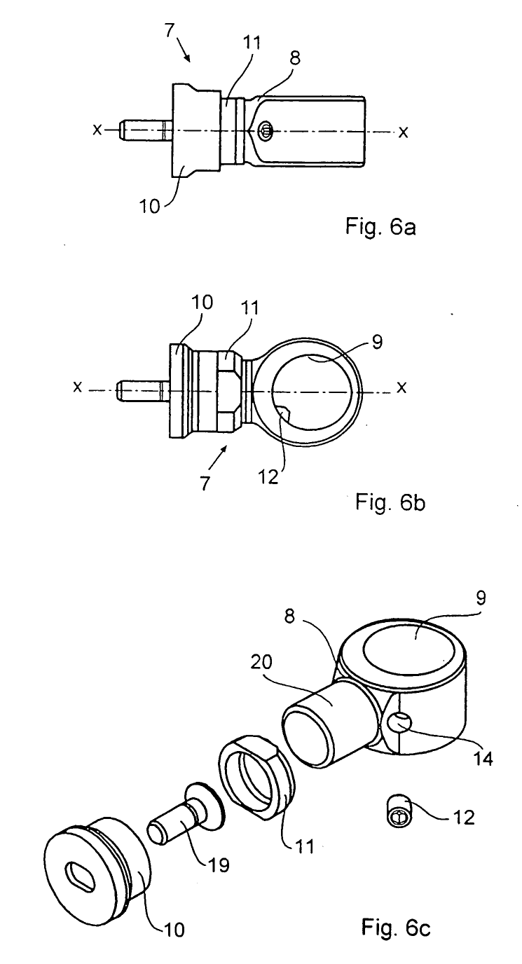

FIGS. 6a to 6c show various views of a holding element according to a second embodiment example of the present invention;

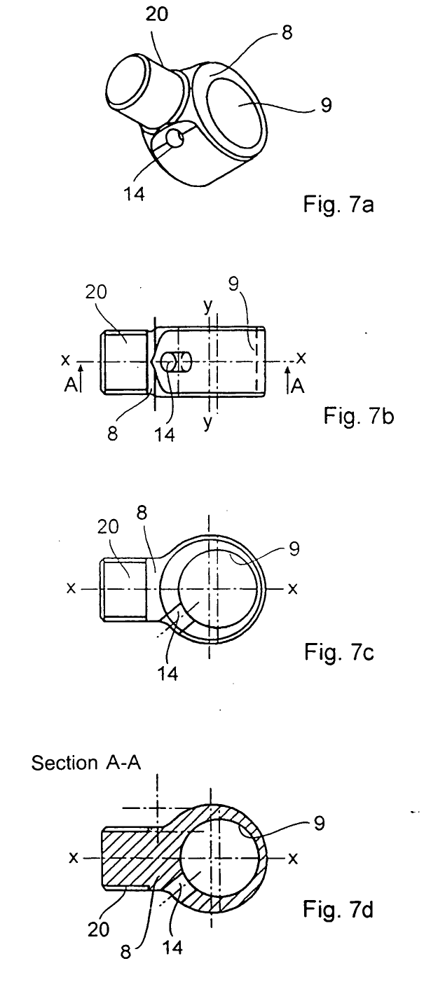

FIGS. 7a to 7d show various views of the holding part of the holding element according to the second embodiment example of the present invention;

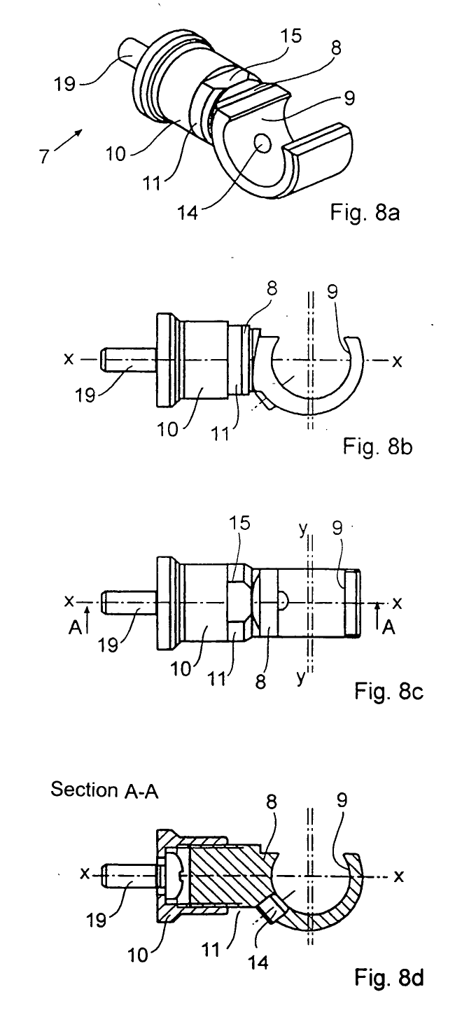

FIGS. 8a to 8d show various views of a holding element according to a third embodiment example of the present invention; and

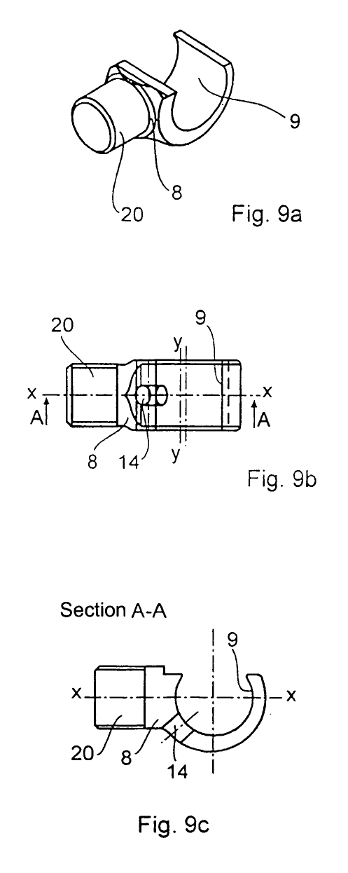

FIGS. 9a to 9c show various views of the holding part of the holding element according to the third embodiment example of the present invention;

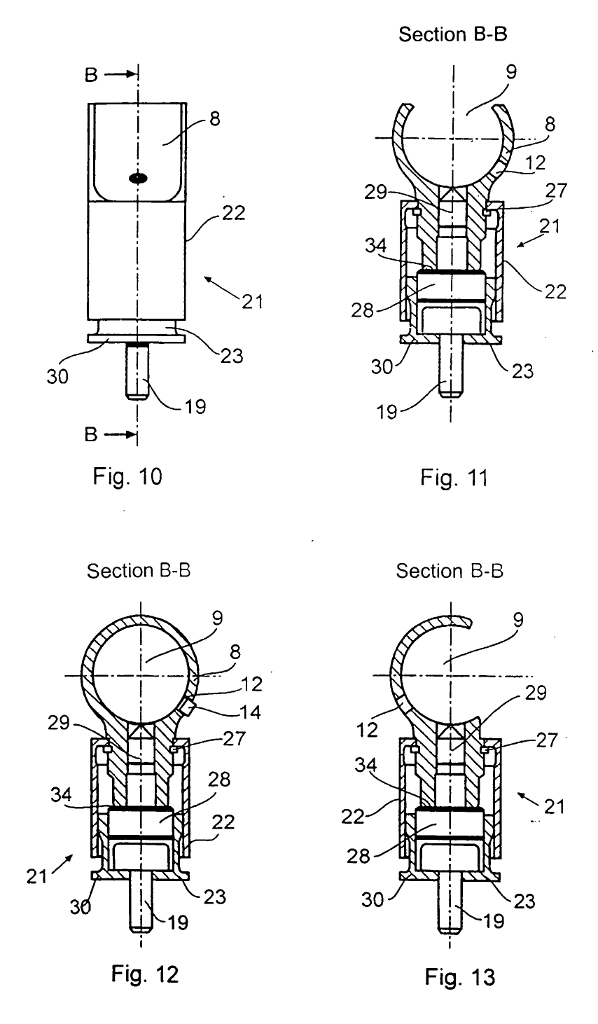

FIG. 10 show a fourth embodiment form of a holding element;

FIG. 11 shows an embodiment form in section according to FIG. 10;

FIG. 12 shows an embodiment form in section according to FIG. 10;

FIG. 13 shows an embodiment form in section according to FIG. 10;

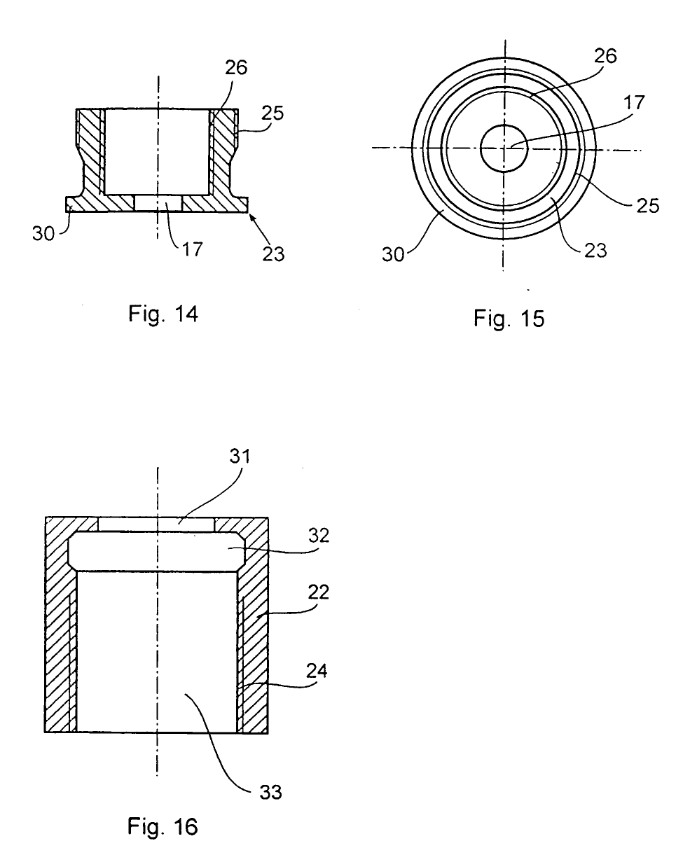

FIG. 14 shows a base part of a second construction in section;

FIG. 15 shows a base part according to FIG. 14 in a top view;

FIG. 16 shows a lock nut in section.

A holding element according to a first embodiment example of the present invention will be described in the following with reference to FIGS. 1 to 5c.

As is shown in FIG. 1, a guide device has, for example, two guide elements which are constructed as cylindrical rods 6. A sliding door 1 is displaceably supported at the rods 6 by four running rollers 3. The running rollers 3 are fastened by means of punctiform fastening elements 5 to the sliding door 1. The sliding door 1 is constructed as a glass door and has through-openings through which the fastening elements 5 are inserted in order to fasten the running rollers 3. The fastening elements terminate flush with the outer top side of the pane of glass 1.

As is shown in FIG. 1, the two rods 6 are arranged at the furniture body 2 in such a way that a first rod 6 is fastened to an upper area of the furniture body 2 and a second rod 6 is fastened to a lower area of the furniture body 2. The rods 6 are fastened to the furniture body 2 by means of holding elements 7. As can be seen particularly from FIG. 1, an adjustable stop 13 is provided at the upper rod 6 at its two lateral ends in order to limit the displacement path of the sliding door 1. The stop is fastened directly to the rod 6 and limits the displacement path of the running rollers 3 on the right- and left-hand sides.

As is shown particularly in FIGS. 2a to 2e and 3a to 3d, the holding element 7 comprises three parts, namely, a holding part 8 which has a male thread and a receiving area 9 for the rod 6 (see FIG. 3), a base part 10 which is fastened to the furniture body 2, and a lock nut 11. The base part 10 and the lock nut 11 are screwed to the male thread area of the holding part 8. The rod 6 is fixed in the receiving area 9 of the holding part 8 (see FIG. 2d) by a stud screw 12. In particular, the holding element 7 according to the invention enables a height adjustment of the rod 6 by screwing the holding part 8 into or out of the base part 10. The distance between the rod 6 and the furniture body 2 is changed in this way. The final position of the holding element 7 can then be secured by the lock nut 11. This makes it possible to align the rod in a simple manner particularly also after mounting.

As is shown particularly in FIG. 1, the rods 6 are fastened to an upper area or lower area of the furniture body 2 by holding elements 7. This makes it possible for the sliding door 1 to be arranged at only a short distance from the open area of the furniture body 2.

As can also be seen from FIGS. 2c and 3c, the receiving area 9 of the holding part 8 for receiving the rod 6 is constructed in such a way that it has two arc-shaped arms which project out over a center axis of the rod 6. Therefore, the rod 6 can not be removed from the holding element 7 in upward or downward direction, but must always be guided out of the holding element 7 in direction of its longitudinal axis.

Further, the distance of the sliding door 1 from the furniture body 2 can be changed in a simple manner by arranging washers between the fastening element 5 and the running rollers 3.

FIGS. 2a to 2e show the holding element 7 according to the invention in a first embodiment example in detail. As is shown in the drawings, the holding element 7 comprises the holding part 8, the base part 10 and the lock nut 11. As can be seen in the perspective view of FIG. 2a and the side view in FIG. 2c, a receiving area 9 is formed in the holding part 8 in particular for receiving the rod 6. The outer diameter of the rod 6 is somewhat smaller than the inner diameter of the receiving area 9. The receiving area 9 is formed as a partial circle which is open in axial direction X-X of the holding element 7. Since the partial circle of the receiving area 9 is greater than a half-circle, a rod 6 that is held by the receiving area 9 can not be removed in direction X-X. The rod must always be removed in its longitudinal axis, i.e., vertical to the axis X-X in direction Y-Y (see FIG. 2b).

A stud screw 12 which is inserted into a threaded bore hole 14 formed in the receiving area 9 (see FIGS. 2d and 3d) serves to secure a rod 6 held in the receiving area 9. The rod 6 can be clamped in the receiving area 9 against the wall of the receiving area by means of the stud screw 12, so that it can no longer be displaced in direction of its longitudinal axis Y-Y.

The holding part 8 of the holding element 7 is shown again in detail in FIGS. 3a to 3d. As is shown there, the holding part 8 has an area 20 which is provided with a thread. The assembly of the holding element according to the invention can be seen particularly form the exploded view in FIG. 2e. First, the lock nut 11 is screwed onto the area 20 of the holding part 8 provided with the thread. Next, a screw 19 is guided from the inside through the opening 17 of the base part 10. As is shown in FIG. 1, the base part can be secured to a furniture body 2 by this screw 19. The opening 17 is preferably formed as an elongated hole, so that an optimal orientation of the base part 10 at the furniture body 2 can be achieved. Subsequently, the holding part 8 provided with the screwed on lock nut 11 is screwed into the female thread 18 of the base part 10 (see FIG. 5c). The height of the holding element 7 can be adjusted in any manner desired. When the desired height is reached, the position can be secured by means of the lock nut 11. As is shown in FIGS. 4a, 4c and 4d, the lock nut 11 has two flattened areas 15 so that a tool can be applied easily. After the holding element 7 is mounted, the rod 6 is guided into the receiving area 9 and is fixed in the desired position by means of the stud screw 12.

Accordingly, the invention can provide a simply constructed holding element for a guide device for sliding doors, which guide device is constructed in a simple and stable manner and makes possible a height adjustment of the holding element 7 in its axial direction X-X. It is noted that the holding part 8 can likewise be constructed with a through-hole in direction X-X, so that the screw 19 can be fixed at the furniture body through this through-hole.

A holding element according to a second embodiment example of the present invention is described in the following with reference to FIGS. 6a to 7d. Identical parts or parts having the same function are designated by the same reference numbers as in the first embodiment example.

As can be seen particularly from FIGS. 7a to 7d, the holding part 8 is formed with an annular receiving area 9 in the second embodiment example in contrast to the first embodiment example. In other words, the receiving area 9 is no longer shaped like a partial circle, but rather is formed completely circularly, so that it fully encloses a rod 6. The rod is fixed again by means of a stud screw 12 in the receiving area 9. Otherwise, the second embodiment example corresponds to the first embodiment example and reference is had to the description given for this first embodiment example.

A holding element according to a third embodiment example of the present invention is described in FIGS. 8a to 9c. Identical parts or parts having the same function are designated by the same reference numbers as in the first embodiment example.

As is shown particularly in FIGS. 8b and 8d, the holding part 8 in the third embodiment example is again formed with a partially circular receiving area 9 similar to the first embodiment example. In contrast to the first embodiment example, the receiving area 9 is arranged in such a way that the free area is not directed in the direction of the axis X-X, i.e., in longitudinal direction of the holding element, but rather is directed 90° vertical to the axis X-X. For this reason, the holding element 7 according to the third embodiment example is especially suitable for being arranged at the front sides of furniture bodies 2, so that a rod arranged in the receiving area 9 is supported from the sides as well as from below. Otherwise, the holding element 7 according to the third embodiment example corresponds to the holding element described in the embodiment examples described above, and further description can be dispensed with.

A holding element according to a fourth embodiment example of the present invention is described in FIGS. 10 to 13. Identical parts or parts having the same function are designated by the same reference numbers as in the preceding embodiment examples.

The holding part 21 shown in FIGS. 10 to 13 is characterized in that there is a holding part 8 having a receiving area 9 similar to the preceding embodiment examples. A union nut 22 which is supported at the holding part on one hand and is fastened to the holding part 8 by a retaining ring 27 so as to be rotatable on the other hand is provided at the holding part 8 so as to be directed in the direction of a base part 23. The union nut is shown in a separate view in FIG. 16. The union nut 22 is constructed in such a way that it has a continuous bore hole 31 which penetrates the union nut 22 along a short area and subsequently ends in an undercut 32 having a larger diameter. On the other side, a bore hole 33 with a thread 24 adjoins the undercut. The thread 24 is screwed onto the base part 23.

The base part 23 is shown separately in FIGS. 14 and 15. Analogous to base part 10, base part 23 has a through-hole 17 for fastening the base part 23 to a furniture body. A bore hole with a female thread 26 adjoins bore hole 17. There is a thread 25 on the outer circumference of the base part 23 which is used for screwing on the union nut 22.

For purposes of mounting, the base part 23 is connected to the furniture body by a screw 19 through the through-hole 17. In order to carry out a height adjustment of the rod 6 inserted into the receiving area 9, a lock screw 28 is screwed into the thread 26 in the base part 23. A height adjustment and therefore a stop for the holding part can be formed by this lock screw 28. When the height adjustment is carried out, the union nut 22 with the holding part 8 is screwed onto the base part 23. In so doing, the union nut 22 can be screwed onto the base part 23 until a base surface 34 of the holding part 8 comes into contact with the lock screw 28. At the same time, the union nut 22 is pulled against the retaining ring 27 of the holding part 8 through this position, which ensures that the holding part 8 is fastened to the base part 23 without play.

One possibility for fixing the rod 6 in the receiving area 9 of the holding part consists in a stud screw 12 located laterally in the holding part 8 inside a threaded bore hole 14 or in an invisible fastening of the rod 9 by a stud screw 29 extending in axial direction of the holding part 21. In this case, the rod 9 would have to be carried out before fitting the union nut 22 on the base part 23.

Further, as was made clear by FIG. 10, a collar 30 is located at the base part 23 for supporting at the furniture body and has the same diameter as the union nut 22. A slender, plain holding element 21 is produced in this way.

The present invention is accordingly directed to a holding element 7, 21 for holding a guide rail 9 for sliding doors, particularly sliding glass doors, with a holding part 8 and a base part 10. The holding part 8 and the base part 10 are connected to one another in such a way that they are adjustable relative to one another in axial direction X-X of the holding element. The holding element 8 has a receiving area 9 for holding a guide rail 9. The base part 10 can be fastened to the furniture body 2, e.g., by means of a screw 19.

### Reference Numbers

1 sliding door

2 furniture body

3 running roller

4 running surface

5 fastening element

6 rod

7 holding element

8 holding part

9 receiving area

10 base part

11 lock nut

12 stud screw

13 stop

14 threaded bore hole

15 flattened area

16 female thread

17 through-hole

18 female thread

19 screw

20 area provided with thread

21 holding element

22 union nut

23 base part

24 female thread

25 male thread

26 female thread

27 retaining ring

28 lock screw

29 stud screw

30 collar

31 bore hole

32 undercut

33 bore hole

34 base surface

1. Holding element (7, 21) for holding a guide rail (6) for sliding doors (1), with a holding part (8) and a base part (10, 23) which are connected to one another in such a way that they are adjustable relative to one another in axial direction (X-X), wherein the holding part (8) has a receiving area (9) for holding the guide rail (6), and the base part (10, 23) can be fastened to a furniture body (2).

2. Holding element according to claim 1, characterized in that the holding part (8) and base part (10) are directly connected to one another by means of a thread (20, 18):

3. Holding element according to claim 1, characterized in that the holding part 8 is connected to a male thread (25) of the base part (23) by means of a union nut (22) with a female thread (24).

4. Holding element according to claim 1 or 2, characterized by a lock nut (11) for fixing a determined position between the holding part (8) and the base part (10).

5. Holding element according to one of claims 1 to 4, characterized in that the receiving area (9) is circular.

6. Holding element according to one of claims 1 to 4, characterized in that the receiving area (9) is constructed as a partial circle, wherein the partial circle is larger than a half-circle.

7. Holding element according to claim 6, characterized in that the partial circle of the receiving area (9) is open in axial direction (X-X) of the holding element (7).

8. Holding element according to claim 6, characterized in that the partial circle of the receiving area (9) is open vertical to the axial direction (X-X) of the holding element (7).

9. Holding element according to one of claims 1 to 8, characterized in that the union nut (22) is held by a retaining ring (27) at the holding part (8) so as to be movable.

10. Holding element according to one of claims 1 to 9, characterized in that the base part (23) has a female thread (26).

11. Holding element according to one of claims 1 to 10, characterized in that a lock screw (28) which is supported against the holding part (8) is used to fix the holding part (8) relative to the union nut (22) in the female thread (26).

12. Holding element according to one of claims 1 to 11, characterized in that the base part (23) has a collar (30) which has the same diameter as the union nut (22).

13. Holding element according to one of claims 1 to 12, characterized in that the guide rail (6) is fixed in the receiving area (9) of the holding part (8) by means of a stud screw (12) and/or a stud screw (29).

14. Holding element according to one of claims 1 to 13, characterized in that the guide rail (6) is constructed as a cylindrical rod.

15. Holding element according to one of claims 1 to 9, characterized in that the base part (10, 23) has a through-opening (17) for receiving a fastening element (19) for fastening the base part (10).

16. Holding element according to claim 10, characterized in that the through-opening (17) is formed as an elongated hole.

17. Holding element according to one of claims 1 to 11, characterized in that the sliding door is a sliding glass door.

18. Holding element according to one of the preceding claims, characterized in that the holding element (7, 21) and the rod (6) are made of stainless steel.
